(19) United States
(12) Patent Application Publication
(10) Pub. No.: US 2007/0255668 A1
(43) Pub. Date: Nov. 1, 2007

(54) Intrinsic discriminant dimension-based signal representation and classification

(75) Inventors: Shubha Kadambe, Alexandria, VA (US); Qin Jiang, Woodland Hills, CA (US)

Correspondence Address: TOPE-MCKAY & ASSOCIATES, 23852 PACIFIC COAST HIGHWAY #311, MALIBU, CA, 90265, US

(73) Assignee: HRL Laboratories, LLC

(21) Appl. No.: 11/413,924

(22) Filed: Apr. 27, 2006

(51) Int. Cl. G06F 15/18; G06E 1/00

(52) U.S. Cl. 706/20

(57) ABSTRACT

The present invention describes a method, system, and computer program product for determining the minimum-dimension of a feature set that is needed for optimal signal representation. The present invention is configured to consider a set of N features to determine a minimum number of features for optimal signal representation. Once the minimum number of features for optimal signal representation is determined, the present invention determines the smallest subset of features that provides for optimal signal classification. Upon determining the smallest subset of features that provide for optimal signal classification, a user may provide those features to a signal classifier for signal classification.

### FIELD OF INVENTION

The present invention relates to a signal classification system, and more particularly, to an intrinsic, discriminant, dimension-based signal representation and classification system that is operable for determining the minimum-dimension of a feature set that is needed for an optimum signal representation and classification.

### BACKGROUND OF INVENTION

Signals are used for a variety of purposes. By way of example, radio-frequency signals carrying information can be used for communication while radar pulses are often used to determine the existence of an object in space or on the ground. Signals are generally measured and classified to know their information content. The information content of a signal is extracted in the form of features that characterize it. The features are then used by classifiers to classify the signal. To better classify a signal, it would be useful to know what features most accurately and uniquely represent the signal. To determine a feature set, the prior art uses algorithms. In existing algorithms, signal-specific features are extracted for the representation, and then the optimum set of features are selected for the classification by applying techniques such as the Principal Component Analysis and the minimization of mutual information. A problem with such algorithms is that they rely on signal-specific features, which are often difficult to ascertain when the signal is combined with background noise or corrupted by the presence of other signals.

Thus, a continuing need exists for a system to identify the minimum-dimension discriminant features that optimally represent and classify signals of interest using a set of non-signal-specific features (i.e., features based on the overall trend of signals or information content) that represent signals robustly.

### SUMMARY OF INVENTION

The present invention is a method for determining the minimum-dimension of a feature set that is needed for optimal signal representation. The method comprise using a processor to perform acts of:
determining a minimum number of features for optimal signal representation; and
determining the smallest subset of features that provides for optimal signal classification, whereby upon determining the smallest subset of features that provide for optimal signal classification, a user may provide those features to a signal classifier for signal classification.

The act of determining the minimum number of features for optimal signal representation further comprises an act of considering a set of N features F={F₁,F₂,Λ,F_{N}}.

In another aspect, the act of determining the minimum number of features for optimal signal representation is performed according to the following:
defining the mutual information between two features Fᵢ and Fⱼ as I(Fᵢ,Fⱼ)=H(Fᵢ)−H(Fᵢ|Fⱼ), where H(Fᵢ) is the entropy and H(Fᵢ|Fⱼ) is the conditional entropy;
determining whether dI>0 or if dI=0;
   when dI=0, there is no gain as Fⱼ is a redundant or a non-discriminant feature;
   when dI>0, Fᵢ and Fⱼ are mutually uncorrelated, and as such, there is information gain by including Fⱼ with Fᵢ, thus the minimum number of features for optimal signal representation is a minimum feature set for which dI>0.

In yet another aspect, determining the smallest subset of features that provides for optimal signal classification is determined according to the following using the minimum feature set:
determining the effective decision boundary feature matrix (EDBFM);
creating a matrix by calculating the eigenvalues and eigenvectors of the EDBFM;
computing a rank of the matrix from non-zero eigenvalues, whereby the rank determines the smallest subset of features that provides for optimal signal classification of the set of N features.

In the act of determining the EDBFM, the EDBFM is calculated according to the following:

$$EDBFM = \frac{1}{{K}^{′}} {\int }_{{S}^{′}} N ( x ) {N}^{′} ( x ) p ( x ) ⅆ x ,$$

where N(x) is the unit normal vector of x, N′(x) is a vector perpendicular to the unit normal vector, p(x) is a probability density function,

$${K}^{′} = {\int }_{{S}^{′}} p ( x ) ⅆ x$$

and S′ is the effective decision boundary which is defined as {x|h(x)=t, xεR₁ or R₂}, where R₁ is the smallest region that contains a certain portion P_{threshold} of class ω₁ and R₂ is the smallest region that contains a certain portion P_{threshold} of class ω₂.

Additionally, in the act of determining the EDBFM, the EDBFM is derived in a multi-class problem having classes ω₁ and ω₂, according to acts of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following acts, with {X₁, X₂,Λ,X_{L}} and {Y₁,Y₂,Λ,Y_{L}} being such samples for classes ω₁ and ω₂, respectively, and performing the following acts for class ω₁;
applying the chi-square threshold test of class ω₁ to the samples of ω₂ and retaining Yⱼ only if (Yⱼ−\hat{M}₁)^{t}\hat{Σ}₁⁻¹(Yⱼ−\hat{M}₁)<Rₜ₂;
for Xᵢ of class ω₁, finding the nearest samples of class ω₂ retained in the act of applying and forming a straight line connecting the samples if the samples have two dimensions, and if the samples have more than two directions, forming a plane between the samples;
finding a point Pᵢ where the straight line or plane connecting the samples found in the act of finding the nearest samples meets the decision boundary;
finding a unit normal vector Nᵢ to the decision boundary at the point Pᵢ;
computing L₁ unit normal vectors by repeating the acts of finding the nearest samples, finding a point Pᵢ, and finding a unit normal vector, for Xᵢ, I=1,2 . . . , L₁, and from these normal vectors computing an estimate of the EDBFM for class ω₁ using:

$${\sum }_{EDBFM}^{1} = \frac{1}{{L}_{1}} {\sum }_{i}^{{L}_{1}} {N}_{i} {N}_{i}^{T} ;$$
for class ω₂, repeating the acts of applying the chi-square threshold test, finding the nearest sample, finding a point Pᵢ, finding a unit normal vector, and computing unit normal vectors; and
calculating an estimate of a final EDBFM using: Σ_{EDBFM}=Σ_{EDBFM}¹+Σ_{EDBFM}².

In yet another aspect, in the act of calculating an estimate of the final EDBFM, the final EDBFM is calculated in a multi-class problem according to the following:

$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$

where M is the number of classes, Σ_{DBFM}^{ij} is the DBFM between classes ωᵢ and ωⱼ, and p(ωᵢ) is the prior probability of class ωᵢ.

Finally, as can be appreciated by one skilled in the art, the present invention also comprises a system and computer program product configured to cause a computer to perform the operations of the method described herein.

### BRIEF DESCRIPTION OF THE DRAWINGS

The objects, features, and advantages of the present invention will be apparent from the following detailed descriptions of the various aspects of the invention in conjunction with reference to the following drawings, where:

FIG. 1 is a block diagram depicting components of a signal representation and classification system according to the present invention;

FIG. 2 is an illustration of a computer program product embodying the present invention;

FIG. 3 illustrates exemplary waveform plots of communication signals;

FIG. 4 illustrates exemplary waveform plots of synthesized radar signals;

FIG. 5 illustrates exemplary waveform plots of real radar pulses;

FIG. 6 illustrates an exemplary cluster plot of real radar pulses from three different emitters, S4, S5, and a4;

FIG. 7A is a table illustrating the classification results of the communication signals shown in FIG. 3, in the form of a confusion matrix using Renyi entropy and skewness features;

FIG. 7B is a table illustrating the classification results of the communication signals shown in FIG. 3, in the form of a confusion matrix using relative entropy and energy ratio features;

FIG. 8A is a table illustrating the classification results of the synthesized radar signals shown in FIG. 4, in the form of a confusion matrix using Renyi entropy and skewness features;

FIG. 8B is a table illustrating the classification results of the synthesized radar signals shown in FIG. 4, in the form of a confusion matrix using Renyi entropy, energy ratio, and frequency change features;

FIG. 9A is a table illustrating the classification results of the real radar signals shown in FIG. 5, in the form of a confusion matrix using Renyi entropy and skewness features; and

FIG. 9B is a table illustrating the classification results of the real radar signals shown in FIG. 5, in the form of a confusion matrix using skewness and kurtosis.

### DETAILED DESCRIPTION

The present invention relates to a signal classification system, and more particularly, to an intrinsic, discriminant, dimension-based signal representation and classification system that is operable for determining the minimum-dimension of a feature set that is needed for an optimum signal representation and classification. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a glossary of terms used in the description and claims is given as a central resource for the reader. Second, a description of various principal aspects of the present invention is provided. Third, an introduction is provided for the reader with a general understanding of the present invention. Fourth, a description of various aspects of the present invention is provided to give an understanding of the specific details. Fifth, an exemplary simulation using the disclosed techniques is provided. Sixth, a conclusion is provided to supply the reader with a brief, yet concise summary of the present invention.

### (1) GLOSSARY

Before describing the specific details of the present invention, a glossary is provided in which various terms used herein and in the claims are defined. The glossary provided is intended to provide the reader with a general understanding for the intended meaning of the terms, but is not intended to convey the entire scope of each term. Rather, the glossary is intended to supplement the rest of the specification in more accurately explaining the terms used. The definitions for kurtosis, skewness, and Renyi entropy were provided by “Wikipedia, The Free Encyclopedia.” Wikipedia can be found at http: //www.wikipedia.org.

Effective Decision Boundary Feature Matrix (EDBFM)—The term “EDBFM” as used with respect to this invention is a matrix that is obtained by integrating the cross product of unit normal vectors of a feature point x and the probability density function of x. EDBFM is defined as:

$$EDBFM = \frac{1}{{K}^{′}} {\int }_{{S}^{′}} N ( x ) {N}^{′} ( x ) p ( x ) ⅆ x ,$$

where N(x) is the unit normal vector of x, p(x) is a probability density function,

$${K}^{′} = {\int }_{{S}^{′}} p ( x ) ⅆ x$$

and S′ is the effective decision boundary which is defined as: {x|h(x)=t, xεR₁ or R₂} where R₁ is the smallest region that contains a certain portion P_{threshold} of class ω₁, and R₂ is the smallest region that contains a certain portion P_{threshold} of class ω₂.

Information Bound—The term “information bound” as used with respect to this invention is the minimum set of features that are mutually uncorrelated, or is the minimum set of features for which dI>0 where dI is the change in information gain.

Instruction Means—The term “instruction means” as used with respect to this invention generally indicates a set of operations to be performed on a computer, and may represent pieces of a whole program or individual, separable, software modules. Non-limiting examples of “instruction means” include computer program code (source or object code) and “hard-coded” electronics (i.e., computer operations coded into a computer chip). The “instruction means” may be stored in the memory of a computer or on a computer-readable medium such as a floppy disk, a CD-ROM, and a flash drive.

Kurtosis—The term “kurtosis” as used with respect to this invention is a measure of the “peakedness” of the probability distribution of a real-valued random variable. Higher kurtosis means more of the variance is due to infrequent extreme deviations, as opposed to frequent modestly-sized deviations.

Renyi entropy—The term “Renyi entropy,” an extension of Shannon entropy, is a means of quantifying the entropy or information content of a system. Renyi entropy characterizes how much information, on average, is gained when the value of a random variable is learned. Alternatively, entropy characterizes the uncertainty about the value of a random variable before learning it; it should not be confused with thermodynamic entropy. Renyi entropy is defined as:

$${H}_{α} ( {p}_{1} , {p}_{2} , … , {p}_{n} ) = \frac{1}{1 - α} l n ( {\sum }_{i = 1}^{n} {p}_{i}^{α} ) ,$$

where pᵢ are probabilities and α>0, α≠1. As a approaches 1, H_{α} converges to Shannon entropy. For some α and αand α′ where α≦α¹, Renyi entropy guarantees that H_{α}≦H_{α}_{¹}.

Skewness—The term “skewness” as used with respect to this invention is a measure of the asymmetry of the probability distribution of a real-valued random variable. Roughly speaking, a distribution has positive skew (right-skewed) if the higher tail is longer and negative skew (left-skewed) if the lower tail is longer.

### (2) PRINCIPAL ASPECTS

The present invention has three “principal” aspects. The first is a signal representation and classification system. The signal representation and classification system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable code stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

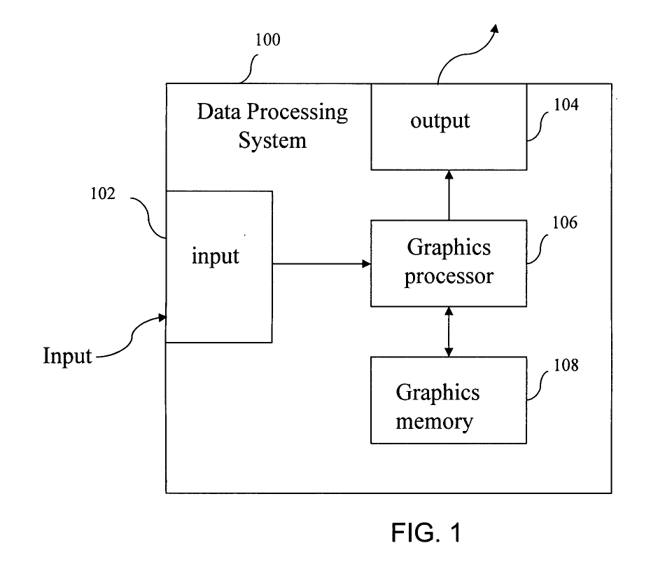

A block diagram depicting the components of a signal representation and classification system of the present invention is provided in FIG. 1. The signal representation and classification system 100 comprises an input 102 for receiving information from at least one sensor for use in detecting the signal. Note that the input 102 may include multiple “ports.” Typically, input is received from at least one sensor, non-limiting examples of which include radio signal sensor, etc. An output 104 is connected with the processor to extract features, and to determine from the extracted features set the minimum number of features needed to get the maximum classification. Note that during training a larger set of features are extracted since it is not known which features provide optimum (i.e., maximum) classification. However, to use the invention one does not have to train the system but needs to extract ONLY the features derived from this invention using the input signals. Output may also be provided to other devices or other programs; e.g., to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software to be manipulated by commands to the processor.

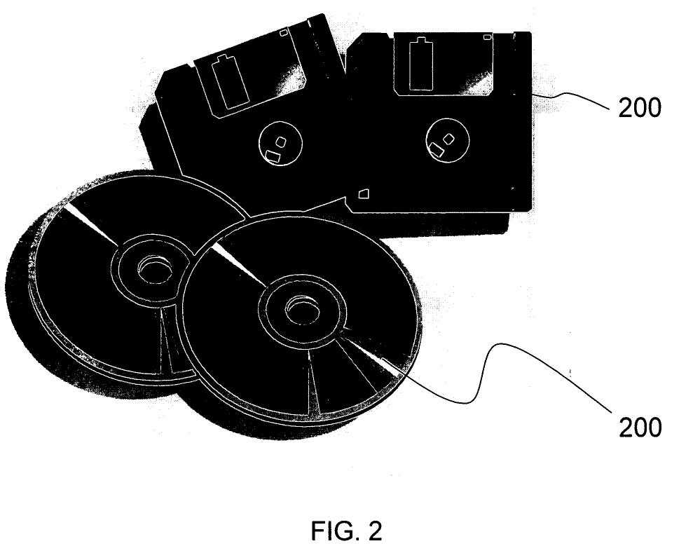

An illustrative diagram of a computer program product embodying the present invention is depicted in FIG. 2. The computer program product 200 is depicted as an optical disk such as a CD or DVD. However, as mentioned previously, the computer program product generally represents computer-readable code stored on any compatible computer-readable medium.

### (3) INTRODUCTION

Generally a set of signal-specific features such as energy and frequency change are used for the representation and classification of signals of interest. However, for robust representation and classification, features that are not so signal-specific such as a measure of information content (e.g., Renyi entropy) and measures of statistical properties of signals (e.g., kurtosis and skewness) are needed. The present invention derives such features. Further, the present invention describes an information bound-based measure to find the minimum-dimension of the feature set that is needed for an optimum signal representation. Similarly, the present invention also describes a decision boundary-based intrinsic discriminant dimension of a feature set that can be used in optimum classification.

An advantage of the present invention is that the computation of features does not correspond to signal-specific features, but instead correspond to overall trends of signals and hence, it is robust. Another advantage is the ability to find the minimum-dimension discriminant features that provide the optimum signal representation and classification. The minimum-dimension indicates that adding other features do not improve the classification and/or representation accuracy. Therefore, the minimum-dimension reduces the computational burden of extracting features that are not going to help in the improvement of accuracy.

This present invention is useful in classification algorithms. Accordingly, the present invention can be utilized with many commercial applications, such as signal confirmation, interference identification, and spectrum management where optimum classification is very important.

In all these applications, first a signal is represented in terms of certain features and then those features are used in classifying the signal. In most applications, the background environment is complex and dynamically changing, creating an environment-corrupted signal. The features that are extracted from the environment-corrupted signal should represent a desired signal's information content and its overall properties, and not the environment that is imprinted on the desired signal. Then the question becomes, what are these features? Further, what is the minimum number or dimension of these features one would need to optimally classify signals? The optimality, in the sense of adding more features, will not improve the classification accuracy. As such, the present invention describes several exemplary robust features that have been developed which correspond to a signal's information content and overall statistical properties. The robust features are described in section 4.1. The present invention also describes that by using a measure based on information bound, an optimum set of features that robustly represent signals can be found. The information bound-based intrinsic dimension of features for signal representation is described in section 4.2. Additionally, a decision boundary-based technique is described to find the minimum-dimension of the feature set that provides the optimum classification accuracy. This approach is described in section 4.3.

### (4) DETAILED DESCRIPTION OF VARIOUS ASPECTS

As described above, the present invention relates to a system for determining the minimum-dimension of a feature set that is needed for optimal signal representation. The system and its operations are described in further detail below.

(4.1) Robust Features

As mentioned before, the desired signals almost always are corrupted by noise associated with dynamically changing environment. As such, the signals that are needed to represent and classify have to be characterized by features that are independent of noise characteristics. The present invention is designed to identify such features. Through a simulation, three features have been identified that can be used to satisfy this requirement. While these features are shown for illustration purposes, the invention is not intended to be limited thereto.

One such feature is the desired signal's information content. This can be measured using an entropy function. This measure can be extended from probability theory to frequency plane or time-frequency plane by treating the spectrum or time-frequency distribution as density functions. In the frequency or time-frequency plane, Renyi entropy is a more appropriate measure for signal information content. So, one of the features that can be used is Renyi entropy. Since the signals are corrupted by noise, they are random signals. Therefore, the statistical features that discriminate signal from noise, such as higher order moments like Skewness and Kurtosis, need to be used. These features are further defined below.

(4.1.1) Renyi Entropy

The Fourier spectrum of the signal x(t) can be used to compute the Renyi entropy. Specifically, it is computed as:

$$\begin{matrix}{F}_{1} = {H}_{α} ( {F}_{x} ( ω ) ) , \\ where \\ {F}_{x} ( ω ) = FFT ( x ( t ) ) , and & ( 1 ) \\ {H}_{α} ( y ) = \frac{1}{1 - α} {log}_{2} ( {\sum }_{i} {( {p}_{y} ( i ) )}^{α} ) , & ( 2 )\end{matrix}$$

with α>0 and α≠1. In the above equations, pₓ(i) denotes the probability, H_{α}(y) is the Renyi entropy that is a generalized version of Shannon entropy, FFT is the fast-fourier transform of the signal x(t), and y=F_x(w). However, it is more robust than Shannon entropy and has one more degree of freedom. When α is equal to one, both the entropies are equal.

(4.1.2) Kurtosis

The kurtosis is a measure of excess or how much energy is in the tails of a distribution function. Since noise generally has a Gaussian distribution, its kurtosis will be close to zero. Therefore, this measure helps in distinguishing between noise and a signal of interest. The kurtosis of a random variable y is defined as:

$${F}_{2} = \frac{1}{{σ}_{y}^{4}} E [ {( y - {m}_{y} )}^{4} ] , \qquad ( 3 )$$

where m denotes mean, E denotes expectation and a denotes standard deviation.

(4.1.3) Skewness

The skewness is a measure of non-symmetry of a distribution. In general, the spectrum of a signal is symmetric while the spectrum of noise tends to be non-symmetric. Therefore, skewness can be used as a feature to distinguish signals from noise. The skewness of a random variable y is defined as:

$${F}_{3} = \frac{1}{{σ}_{y}^{3}} E [ {( y - {m}_{y} )}^{3} ] . \qquad ( 4 )$$

In equations (3) and (4) above m_{y}=E[y]−mean, and σ_{y}²=E[(y−m_{y})(y−m_{y})*]−variance.

Additionally, * denotes conjugation.

(4.2) Information Bound-Based Intrinsic Dimension of Features for Signal Representation

Consider a set of N features F={F₁,F₂,Λ, F_{N}}. The mutual information between two features Fᵢ and Fⱼ is defined as: I(Fᵢ,Fⱼ)=H(F)−H(Fᵢ|Fⱼ), where H(Fᵢ) is the entropy and H(Fᵢ|Fⱼ) is the conditional entropy. The mutual information dI>0 if Fᵢ and Fⱼ are mutually uncorrelated. In other words, there is information gain by including Fⱼ with Fᵢ. If there is no gain then dI=0. This implies that Fⱼ is a redundant or a non-discriminant feature. Based on this, the information bound is defined as the minimum set of features which are mutually uncorrelated or as the minimum set of features for which dI>0. This minimum set is defined as the intrinsic dimension of the features for optimal signal representation.

(4.3) Decision Boundary-Based Intrinsic Dimension of Features for Classification

In the context of classification, the intrinsic dimension is defined as the smallest subset of features that provides the same classification accuracy as that can be obtained from the original set. This dimension can be found based on the effective decision boundary feature matrix (EDBFM). This is defined as:

$$EDBFM = \frac{1}{{K}^{′}} {\int }_{{S}^{′}} N ( x ) {N}^{′} ( x ) p ( x ) ⅆ x ,$$

where N(x) is the unit normal vector of x, N′(x) is a vector perpendicular to the unit normal vector, p(x) is a probability density function,

$${K}^{′} = {\int }_{{S}^{′}} p ( x ) ⅆ x$$

and S′ is the effective decision boundary which is defined as: {x|h(x)=t, Xε R₁ or R₂} where R₁ is the smallest region that contains a certain portion P_{threshold} of class ω₁, and R₂ is the smallest region that contains a certain portion P_{threshold} of class ω₂. The integral in equation (5) is performed over the effective decision boundary. However, if the integral in equation (5) is performed over the decision boundary, a decision boundary feature matrix (DBFM) is obtained. It can be shown that the rank of this DBFM of a pattern classification problem is the intrinsic discriminant dimension of the feature set. The rank corresponds to the dimension of the eigenvectors associated with the non-zero eigenvalues of DBFM.

The numerical procedure to find the EDBFM for a two-class problem is as follows:
a. Classify the training samples using the full dimension feature set. Apply the chi-square threshold test to the correctly classified training samples of each class and delete the outlier. That is, for class ω₁, retain a sample X only if (X−\hat{M}ᵢ)ⁱ\hat{Σ}ᵢ⁻¹(X−\hat{M}ᵢ)<Rₜ₁, where \hat{M}ᵢ and \hat{Σ}ᵢ are the mean and covariance of class ω₁, and subscript t denotes a particular threshold. Use only the correctly classified training samples that passed the chi-square threshold test in the following acts. Let {X₁, X₂,Λ, X_{L}} and {Y₁, Y₂,Λ,Y_{L}}be such samples for class ω₁ and ω₂, respectively. For class ω₁, perform the following acts.
b. Apply the chi-square threshold test of class ω₁ to the samples of ω₂ and retain Yⱼ only if (Yⱼ−\hat{M}₁)^{t}\hat{Σ}₁⁻¹(Yⱼ−\hat{M}₁)<Rₜ₂.
c. For Xᵢ of class ω₁, find the nearest samples of class ω₂ retained in act (b).
d. Find the point Pᵢ where the straight line connecting the pair of samples found in act (c) meets the decision boundary.
e. Find the unit normal vector Nᵢ to the decision boundary at the point Pᵢ found in act (d).
f. Compute L₁ unit normal vectors by repeating acts (c) to (e) for Xᵢ, I=1, 2 . . . , L₁. From these normal vectors, compute an estimate of the EDBFM for class ω₁ using:

$${\sum }_{EDBFM}^{1} = \frac{1}{{L}_{1}} {\sum }_{i}^{{L}_{1}} {N}_{i} {N}_{i}^{T} .$$

Repeat acts (b) to (f) for class ω₂
g. Calculate an estimate of the final EDBFM using: Σ_{EDBRM}=Σ_{EDBFM}¹+ΣEDBFM².
h. Compute the eigenvalues and eigenvectors of EDBFM. From the non-zero eigenvalues, compute the rank of the matrix. The rank will determine the intrinsic discriminant dimension of the feature set.

Note that the chi-square test in act (a) will eliminate the outliers. The chi-square test with respect to the other class in act (b) is needed to concentrate on the effective decision boundary. For a multi-class problem, the same acts as above are performed. However, the EDBFM is computed using the following equation:

$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$

where M is the number of classes, Σ_{DBFM}^{ij} is the DBFM between classes ωᵢ and ωⱼ, and p(ωᵢ) is the prior probability of class ωᵢ. Then the eigenvalues and eigenvectors of this matrix are computed. The rank of the matrix determined from the non-zero eigenvalues indicates the intrinsic discriminant dimension of the feature matrix.

### (5) EXEMPLARY SIMULATION

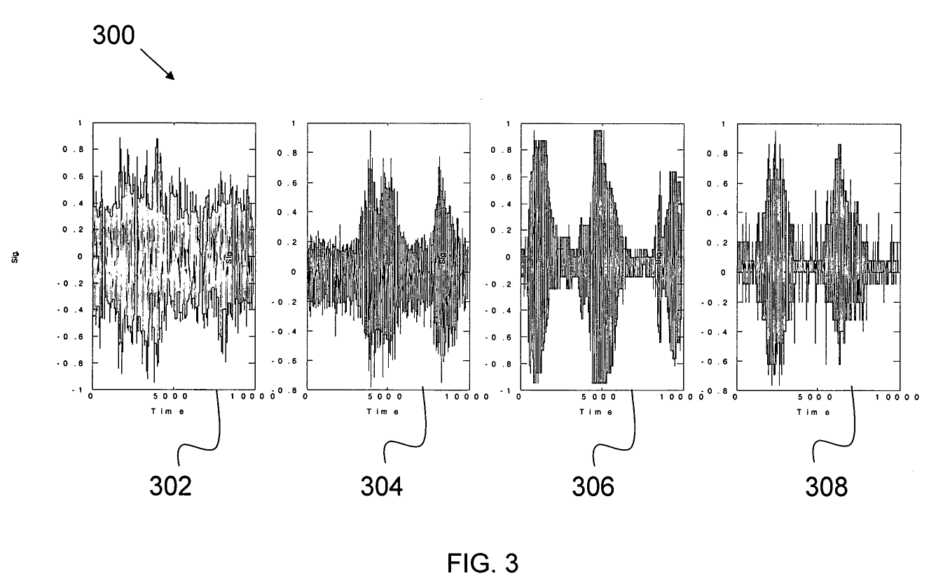

Several types of communication and radar signals were considered for the verification of the above-disclosed algorithm and features. In the case of radar, real signals were also considered. Examples of waveforms of these signals are plotted in FIGS. 3 through 5.

FIG. 3 is a plot of communication signals 300 where the signals are plotted against time, showing single side lobe-modulated speech signal 302, frequency-modulated speech signal 304, and two different phase shift key-modulated speech signals (i.e., 306 and 308), respectively from top to bottom.

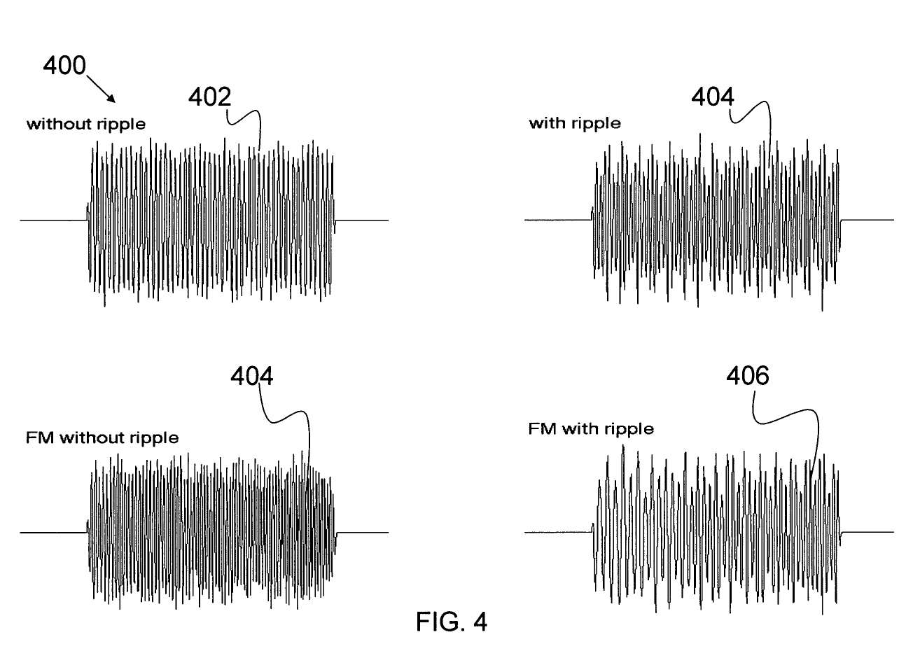

FIG. 4 illustrates exemplary waveform plots of synthesized radar signals 400 where the signals are plotted against time, showing the signals without a ripple 402, with a ripple 404, frequency modulation (FM) without a ripple 406, and FM with a ripple 408.

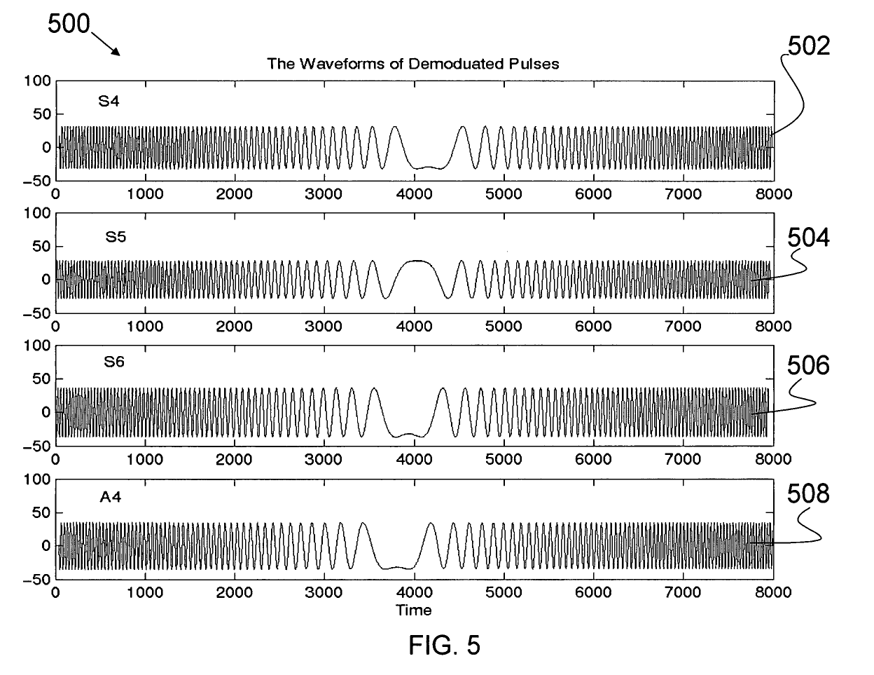

FIG. 5 illustrates exemplary waveform plots of real radar pulses 500 from four different radar systems, S4 502, S5 504, S6 506, and A4 508.

Both the signal-specific features like energy ratio and frequency change, and the non-signal-specific robust features mentioned above (i.e., section 4.1) were extracted for all of these signals. The mutual correlation or mutual information between them was computed. In all these cases, information bound was reached for the features Renyi entropy, skewness and kurtosis.

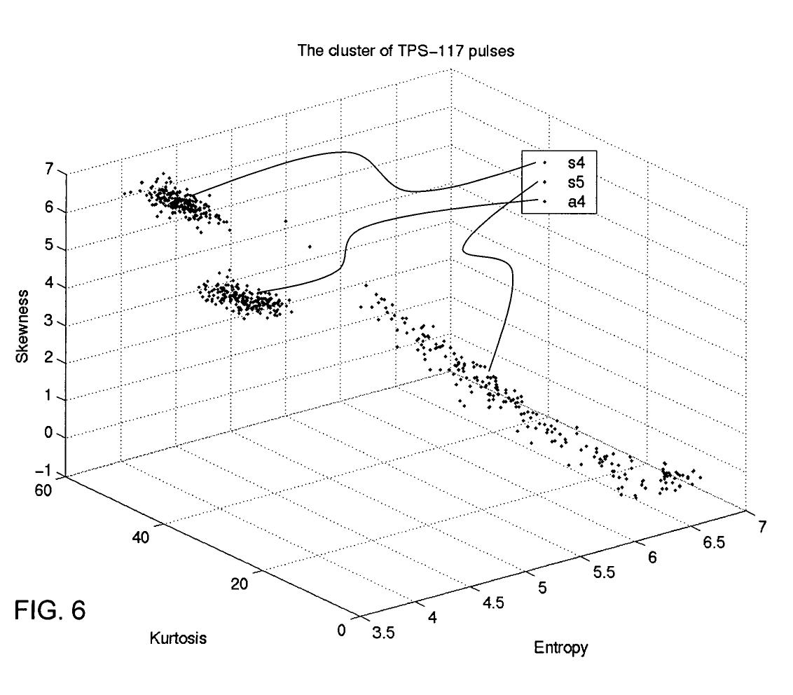

FIG. 6 illustrates a cluster plot of Renyi entropy, skewness, and kurtosis, plotted for real radar signals. As shown in FIG. 6, these features form non-overlapping clusters for the three signal types. This indicates that radar pulses can be optimally represented by these features. Additional experiments provided similar results for the other signal types mentioned above. The results imply that these three features are enough to uniquely represent at least some classes of signals.

Next, for the features (i.e., Renyi entropy, skewness, and kurtosis) that were extracted from all the signal types mentioned above, the intrinsic discriminant dimension using the decision boundary (i.e., as described in section 4.3) was determined. From the eigenvalues and eigenvectors of the EDBFM of three types of signals—communication signals (shown in FIG. 3), synthesized radar signals (shown in FIG. 4) and real radar signals (shown in FIG. 5), it was found that the features corresponding to non-zero eigenvalues are: Renyi entropy and Skewness. This implies that only these two features are needed to obtain the optimum classification accuracy.

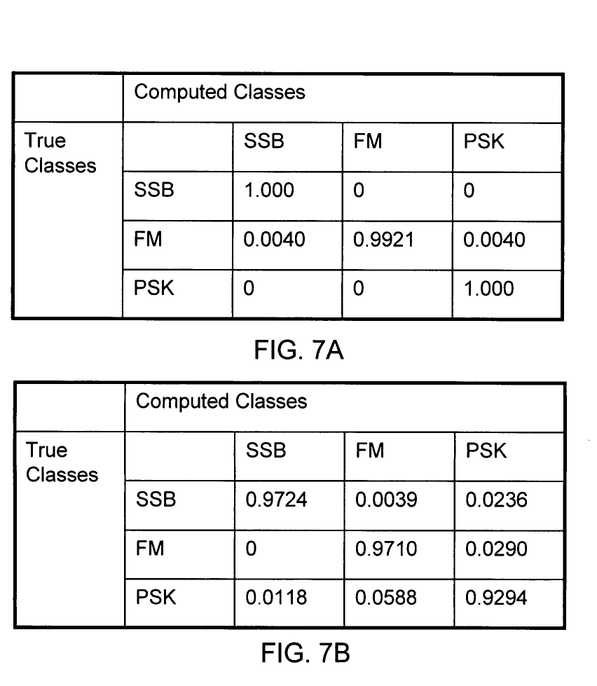

FIGS. 7 through 9 illustrate tables in the form of confusion matrices, showing the classification results of communication signals, synthesized radar pulses, and real radar signals.

More specifically, FIG. 7A is a table illustrating the classification results of the communication signals shown in FIG. 3, in the form of a confusion matrix using Renyi entropy and skewness features, while FIG. 7B is a confusion matrix using relative entropy and energy ratio features.

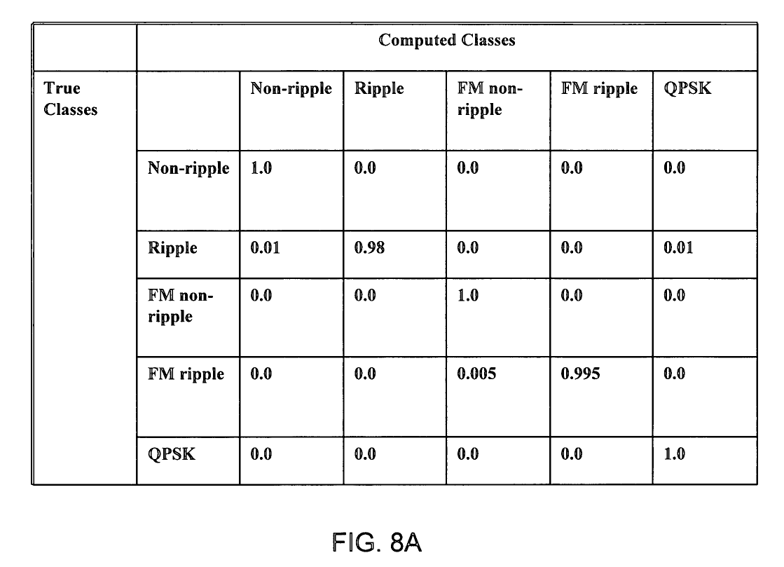

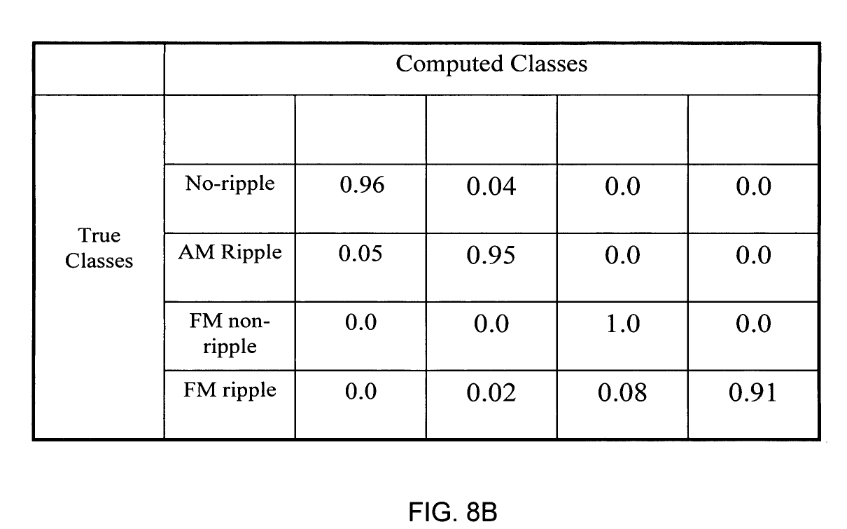

FIG. 8A is a table illustrating the classification results of the synthesized radar signals shown in FIG. 4, in the form of a confusion matrix using Renyi entropy and skewness features, while FIG. 8B is a confusion matrix using Renyi entropy, energy ratio, and frequency change features.

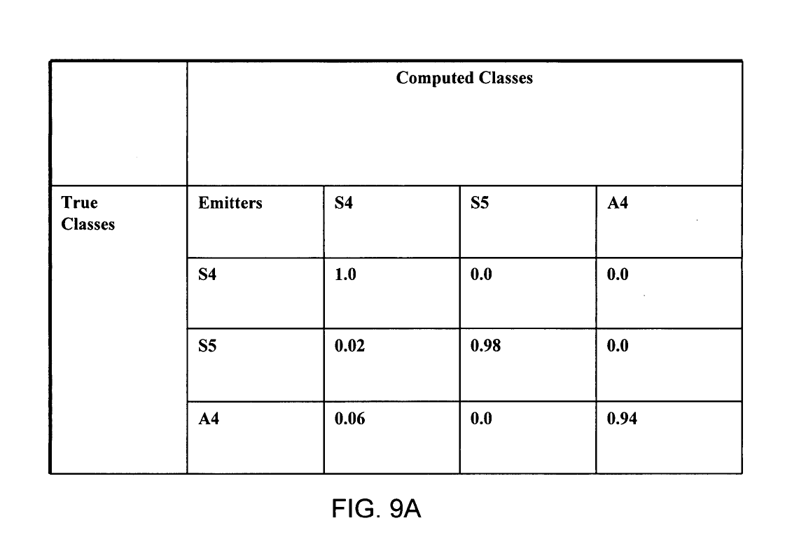

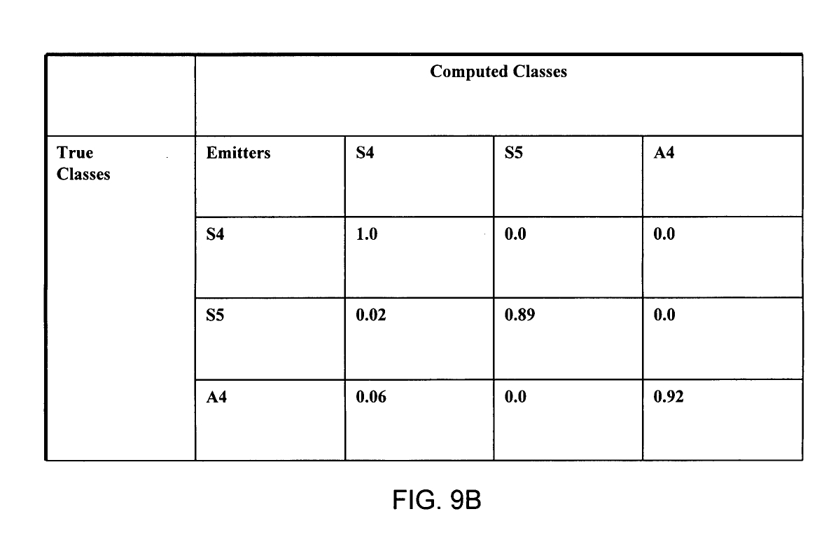

Finally, FIG. 9A is a table illustrating the classification results of the real radar signals shown in FIG. 5, in the form of a confusion matrix using Renyi entropy and skewness features, while FIG. 9B is a confusion matrix using skewness and kurtosis.

From the tables presented in FIGS. 7 through 9, it can be seen that the maximum classification accuracy can be obtained using only Renyi entropy and skewness features.

### (6) CONCLUSION

The present invention describes a method for obtaining the robust minimum features that can optimally represent and classify signals. The minimum-dimension of the feature set that is needed for the representation is derived from the disclosed information bound; whereas the minimum-dimension of the feature set that is needed for the classification is derived from the decision boundary. The described concepts were verified by performing a simulation using different types of signals. Through the simulation, it was shown that at least for the types of signals considered in the simulation, the Renyi entropy, kurtosis and skewness seem to be universal features that provide the optimum representation. For classification, it appears that the subset of these features namely, Renyi entropy and skewness are the optimum features. One skilled in the art can appreciate that the present invention is not limited to the above features and signals and can be used for any signal to determine the minimum-dimension of the feature set that is needed for representation and classification.

What is claimed is:

1. A method for determining the minimum-dimension of a feature set that is needed for optimal signal representation, the method comprising using a processor to perform acts of:
determining a minimum number of features for optimal signal representation; and
determining the smallest subset of features that provides for optimal signal classification, whereby upon determining the smallest subset of features that provide for optimal signal classification, a user may provide those features to a signal classifier for signal classification.

2. A method as set forth in claim 1, wherein the act of determining the minimum number of features for optimal signal representation further comprises an act of considering a set of N features F={F₁,F₂,Λ, F_{N}}.

3. A method as set forth in claim 2, wherein the act of determining the minimum number of features for optimal signal representation is performed according to the following:
defining the mutual information between two features Fᵢ and Fⱼ as I(Fᵢ,Fⱼ)=H(Fᵢ)−H(Fᵢ|Fⱼ), where H(Fᵢ) is the entropy and H(Fᵢ|Fⱼ) is the conditional entropy;
determining whether dI>0 or if dI=0;
when dI=0, there is no gain as Fⱼ is a redundant or a non-discriminant feature;
when dI=0,Fᵢ and Fⱼ are mutually uncorrelated, and as such, there is information gain by including Fⱼ with Fᵢ, thus the minimum number of features for optimal signal representation is a minimum feature set for which dI>0.

4. A method as set forth in claim 3, wherein determining the smallest subset of features that provides for optimal signal classification is determined according to the following using the minimum feature set:
determining the effective decision boundary feature matrix (EDBFM);
creating a matrix by calculating the eigenvalues and eigenvectors of the EDBFM;
computing a rank of the matrix from non-zero eigenvalues, whereby the rank determines the smallest subset of features that provides for optimal signal classification of the set of N features.

5. A method as set forth in claim 4, wherein in the act of determining the EDBFM, the EDBFM is calculated according to the following:
$$EDBFM = \frac{1}{{K}^{′}} {\int }_{{S}^{′}} N ( x ) {N}^{′} ( x ) p ( x ) ⅆ x ,$$
where N(x) is the unit normal vector of x, N′(x) is a vector perpendicular to the unit normal vector, p(x) is a probability density function,
$${K}^{′} = {\int }_{{S}^{′}} p ( x ) ⅆ x$$
and S′ is the effective decision boundary which is defined as {x|h(x)=t, xεR₁ or R₂}, where R₁ is the smallest region that contains a certain portion P_{threshold} of class ω₁ and R₂ is the smallest region that contains a certain portion P_{threshold} of class ω₂.

6. A method as set forth in claim 5, wherein in the act of determining the EDBFM, the EDBFM is derived in a multi-class problem having classes ω₁ and ω₂, according to acts of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following acts, with {X₁, X₂,Λ,X_{L}} and {Y₁, Y₂,Λ, Y_{L}} being such samples for classes ω₁ and ω₂, respectively, and performing the following acts for class ω₁;
applying the chi-square threshold test of class ω₁ to the samples of ω₂ and retaining Yⱼ only if (Yⱼ−\hat{M}₁)^{t}\hat{Σ}₁⁻¹(Yⱼ−\hat{M}₁)<Rₜ₂;
for Xᵢ of class ω₁, finding the nearest samples of class ω₂ retained in the act of applying and forming a straight line connecting the samples if the samples have two dimensions, and if the samples have more than two directions, forming a plane between the samples;
finding a point Pᵢ where the straight line or plane connecting the samples found in the act of finding the nearest samples meets the decision boundary;
finding a unit normal vector Nᵢ to the decision boundary at the point Pᵢ;
computing L₁ unit normal vectors by repeating the acts of finding the nearest samples, finding a point Pᵢ, and finding a unit normal vector, for Xᵢ, I=1,2 . . . , L₁, and from these normal vectors computing an estimate of the EDBFM for class ω₁ using:
$${\sum }_{EDBFM}^{1} = \frac{1}{{L}_{1}} {\sum }_{i}^{{L}_{1}} {N}_{i} {N}_{i}^{T} ;$$
for class ω₂, repeating the acts of applying the chi-square threshold test, finding the nearest sample, finding a point Pᵢ, finding a unit normal vector, and computing unit normal vectors; and
calculating an estimate of a final EDBFM using: Σ_{EDBFM}=Σ_{EDBFM}¹+Σ_{EDBFM}².

7. A method as set forth in claim 6, wherein in the act of calculating an estimate of the final EDBFM, the final EDBFM is calculated in a multi-class problem according to the following:
$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$
where M is the number of classes, Σ_{DBFM}^{ij} is the DBFM between classes ωᵢ and ωⱼ, and p(ωᵢ) is the prior probability of class ωᵢ.

8. A method as set forth in claim 2, wherein determining the smallest subset of features that provides for optimal signal classification is determined according to the following using the minimum number of features for optimal signal representation:
determining the effective decision boundary feature matrix (EDBFM);
creating a matrix by calculating eigenvalues and eigenvectors of the EDBFM;
computing a rank of the matrix from non-zero eigenvalues, whereby the rank determines the smallest subset of features that provides for optimal signal classification of the set of N features.

9. A method as set forth in claim 8, wherein in the act of determining the EDBFM, the EDBFM is calculated according to the following:
$$EDBFM = \frac{1}{{K}^{′}} {\int }_{{S}^{′}} N ( x ) {N}^{′} ( x ) p ( x ) ⅆ x ,$$
where N(x) is the unit normal vector of x, N′(x) is a vector perpendicular to the unit normal vector, p(x) is a probability density function,
$${K}^{′} = {\int }_{{S}^{′}} p ( x ) ⅆ x$$
and S′ is the effective decision boundary which is defined as {x|h(x)=t, XεR₁ or R₂}, where R₁ is the smallest region that contains a certain portion P_{threshold} of class ω₁ and R₂ is the smallest region that contains a certain portion P_{threshold} of class ω₂.

10. A method as set forth in claim 8, wherein in the act of determining the EDBFM, the EDBFM is derived in a multi-class problem having classes ω₁ and ω₂, according to acts of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following acts, with {X₁, X₂,Λ, X_{L}} and {Y₁, Y₂,Λ, Y_{L}} being such samples for classes ω₁ and ω₂, respectively, and performing the following acts for class ω₁;
applying the chi-square threshold test of class ω₁ to the samples of ω₂ and retaining Yⱼ only if (Yⱼ−\hat{M}₁)^{t}Σ₁⁻¹(Yⱼ−\hat{M}₁)<Rₜ₂;
for Xᵢ of class ω₁, finding the nearest samples of class ω₂ retained in the act of applying and forming a straight line connecting the samples if the samples have two dimensions, and if the samples have more than two directions, forming a plane between the samples;
finding a point Pᵢ where the straight line or plane connecting the samples found in the act of finding the nearest samples meets the decision boundary;
finding a unit normal vector Nᵢ to the decision boundary at the point Pᵢ;
computing L₁ unit normal vectors by repeating the acts of finding the nearest samples, finding a point Pᵢ, and finding a unit normal vector, for Xᵢ, I=1,2 . . . , L₁, and from these normal vectors computing an estimate of the EDBFM for class ω₁ using:
$${\sum }_{EDBFM}^{1} = \frac{1}{{L}_{1}} {\sum }_{i}^{{L}_{1}} {N}_{i} {N}_{i}^{T} ;$$
for class ω₂, repeating the acts of applying the chi-square threshold test, finding the nearest sample, finding a point Pᵢ, finding a unit normal vector, and computing unit normal vectors; and
calculating an estimate of a final EDBFM using: Σ_{EDBFM}=ΣEDBFM¹+ΣEDBFM².

11. A method as set forth in claim 10, wherein in the act of calculating an estimate of the final EDBFM, the final EDBFM is calculated in a multi-class problem according to the following:
$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$
where M is the number of classes, ΣDBFM^{ij} is the DBFM between classes ωᵢ and ωⱼ, and p(ωᵢ) is the prior probability of class ωᵢ.

12. A computer program product for determining the minimum-dimension of a feature set that is needed for optimal signal representation, the computer program product comprising computer-readable instruction means encoded on a computer-readable medium for causing a computer to:
determine a minimum number of features for optimal signal representation; and
determine the smallest subset of features that provides for optimal signal classification, whereby upon determining the smallest subset of features that provide for optimal signal classification, a user may provide those features to a signal classifier for signal classification.

13. A computer program product as set forth in claim 12, wherein when determining the minimum number of features for optimal signal representation, the computer program product further comprises instruction means for considering a set of N features F={F₁,F₂,Λ, F_{N}} for determining the minimum number of features.

14. A computer program product as set forth in claim 13, wherein when determining the minimum number of features for optimal signal representation, the computer program product further comprises instruction means for causing a computer to perform the following operations:
defining the mutual information between two features Fᵢ and Fⱼ as I(Fᵢ,Fⱼ)=H(Fᵢ)−H(Fᵢ|Fⱼ), where H(Fᵢ) is the entropy and H(Fᵢ|Fⱼ) is the conditional entropy;
determining whether dI>0 or if dI=0;
when dI=0, there is no gain as Fⱼ is a redundant or a non-discriminant feature;
when dI>0,Fᵢ and Fⱼ are mutually uncorrelated, and as such, there is information gain by including Fⱼ with Fᵢ, thus the minimum number of features for optimal signal representation is a minimum feature set for which dI>0.

15. A computer program product as set forth in claim 14, further comprising instruction means for causing a computer to determine the smallest subset of features that provides for optimal signal classification using the minimum feature set and performing the following operations:
determining the effective decision boundary feature matrix (EDBFM);
creating a matrix by calculating the eigenvalues and eigenvectors of the EDBFM;
computing a rank of the matrix from non-zero eigenvalues, whereby the rank determines the smallest subset of features that provides for optimal signal classification of the set of N features.

16. A computer program product as set forth in claim 15, further comprising instruction means for causing a computer to determine the EDBFM by performing a calculation according to the following:
$$EDBFM = \frac{1}{{K}^{′}} {\int }_{{S}^{′}} N ( x ) {N}^{′} ( x ) p ( x ) ⅆ x ,$$
where N(x) is the unit normal vector of x, N′(x) is a vector perpendicular to the unit normal vector, p(x) is a probability density function,
$${K}^{′} = {\int }_{{S}^{′}} p ( x ) ⅆ x$$
and S′ is the effective decision boundary which is defined as {x|h(x)=t, xεR₁ or R₂}, where R₁ is the smallest region that contains a certain portion P_{threshold} of class ω₁ and R₂ is the smallest region that contains a certain portion P_{threshold} of class ω₂.

17. A computer program product as set forth in claim 16, further comprising instruction means for causing a computer to determine the EDBFM in a multi-class problem having classes ω₁ and ω₂, by performing operations of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following operations, with {X₁, X₂,Λ,X_{L}} and {Y₁, Y₂, Λ,Y_{L}} being such samples for classes ω₁ and ω₂, respectively, and performing the following operations for class ω₁;
applying the chi-square threshold test of class ω₁ to the samples of ω₂ and retaining Yⱼ only if (Yⱼ−\hat{M}₁)^{t}\hat{Σ}₁⁻¹(Yⱼ−\hat{M}₁)<Rₜ₂;
for Xᵢ of class ω₁, finding the nearest samples of class ω₂ retained in the operation of applying and forming a straight line connecting the samples if the samples have two dimensions, and if the samples have more than two directions, forming a plane between the samples;
finding a point Pᵢ where the straight line or plane connecting the samples found in the operation of finding the nearest samples meets the decision boundary;
finding a unit normal vector Nᵢ to the decision boundary at the point Pᵢ;
computing L₁ unit normal vectors by repeating the operations of finding the nearest samples, finding a point Pᵢ, and finding a unit normal vector, for Xᵢ, I=1,2 . . . , L₁, and from these normal vectors computing an estimate of the EDBFM for class ω₁ using:
$${\sum }_{EDBFM}^{1} = \frac{1}{{L}_{1}} {\sum }_{i}^{{L}_{1}} {N}_{i} {N}_{i}^{T} ;$$
for class ω₂, repeating the operations of applying the chi-square threshold test, finding the nearest sample, finding a point Pᵢ, finding a unit normal vector, and computing unit normal vectors; and
calculating an estimate of a final EDBFM using: Σ_{EDBFM}=Σ_{EDBFM}¹+Σ_{EDBFM}².

18. A computer program product as set forth in claim 17, further comprising instruction means for causing a computer calculate an estimate of the final EDBFM in a multi-class problem by performing a calculation according to the following:
$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$
where M is the number of classes, ΣDBFM^{ij} is the DBFM between classes ωᵢ and ωⱼ, and p(ωᵢ) is the prior probability of class ωᵢ.

19. A computer program product as set forth in claim 13, further comprising instruction means for causing a computer to determine the smallest subset of features that provides for optimal signal classification using the minimum feature set and performing the following operations:
determining the effective decision boundary feature matrix (EDBFM);
creating a matrix by calculating the eigenvalues and eigenvectors of the EDBFM;
computing a rank of the matrix from non-zero eigenvalues, whereby the rank determines the smallest subset of features that provides for optimal signal classification of the set of N features.

20. A computer program product as set forth in claim 19, further comprising instruction means for causing a computer to determine the EDBFM by performing a calculation according to the following:
$$EDBFM = \frac{1}{{K}^{′}} {\int }_{{S}^{′}} N ( x ) {N}^{′} ( x ) p ( x ) ⅆ x ,$$
where N(x) is the unit normal vector of x, N′(x) is a vector perpendicular to the unit normal vector, p(x) is a probability density function,
$${K}^{′} = {\int }_{{S}^{′}} p ( x ) ⅆ x$$
and S′ is the effective decision boundary which is defined as {x|h(x)=t, xεR₁ or R₂}, where R₁ is the smallest region that contains a certain portion P_{threshold} of class ω₁ and R₂ is the smallest region that contains a certain portion P_{threshold} of class ω₂.

21. A computer program product as set forth in claim 19, further comprising instruction means for causing a computer to determine the EDBFM in a multi-class problem having classes ω₁ and ω₂, by performing operations of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following operations, with {X₁, X₂,Λ,X_{L}} and {Y₁, Y₂,Λ,Y_{L}} being such samples for classes ω₁ and ω₂, respectively, and performing the following operations for class ω₁;
applying the chi-square threshold test of class ω₁ to the samples of ω₂ and retaining Yⱼ only if (Yⱼ−\hat{M}₁)^{t}\hat{Σ}₁⁻¹(Yⱼ−\hat{M}₁)<Rₜ₂;
for Xᵢ of class ω₁, finding the nearest samples of class ω₂ retained in the operation of applying and forming a straight line connecting the samples if the samples have two dimensions, and if the samples have more than two directions, forming a plane between the samples;
finding a point Pᵢ where the straight line or plane connecting the samples found in the operation of finding the nearest samples meets the decision boundary;
finding a unit normal vector Nᵢ to the decision boundary at the point Pᵢ;
computing L₁ unit normal vectors by repeating the operations of finding the nearest samples, finding a point Pᵢ, and finding a unit normal vector, for Xᵢ, I=1,2 . . . L₁, and from these normal vectors computing an estimate of the EDBFM for class ω₁ using:
$${\sum }_{EDBFM}^{1} = \frac{1}{{L}_{1}} {\sum }_{i}^{{L}_{1}} {N}_{i} {N}_{i}^{T} ;$$
for class ω₂, repeating the operations of applying the chi-square threshold test, finding the nearest sample, finding a point Pᵢ, finding a unit normal vector, and computing unit normal vectors; and
calculating an estimate of a final EDBFM using: Σ_{EDBFM}=ΣEDBFM¹+ΣEDBFM².

22. A computer program product as set forth in claim 21, further comprising instruction means for causing a computer calculate an estimate of the final EDBFM in a multi-class problem by performing a calculation according to the following:
$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$
where M is the number of classes, ΣDBFM^{ij} is the DBFM between classes ωᵢ and ωⱼ, and p(ωᵢ) is the prior probability of class ωᵢ.

23. A system for determining the minimum-dimension of a feature set that is needed for optimal signal representation, the system comprising a processor configured to perform operations of:
determining a minimum number of features for optimal signal representation; and
determining the smallest subset of features that provides for optimal signal classification, whereby upon determining the smallest subset of features that provide for optimal signal classification, a user may provide those features to a signal classifier for signal classification.

24. A system as set forth in claim 23, wherein when determining the minimum number of features for optimal signal representation, the system is further configured to consider a set of N features F={F₁,F₂,Λ, F_{N}}.

25. A system as set forth in claim 24, wherein when determining the minimum number of features for optimal signal representation, the system is further configured to perform operations of:
defining the mutual information between two features Fᵢ and Fⱼ as I(Fᵢ,Fⱼ)=H(Fᵢ)−H(Fᵢ|Fⱼ), where H(Fᵢ) is the entropy and H(Fᵢ|Fⱼ) is the conditional entropy;
determining whether dI>0 or if dI=0;
when dI=0, there is no gain as Fⱼ is a redundant or a non-discriminant feature;
when dI>0, Fᵢ and Fⱼ are mutually uncorrelated, and as such, there is information gain by including Fⱼ with Fᵢ, thus the minimum number of features for optimal signal representation is a minimum feature set for which dI>0.

26. A system as set forth in claim 25, wherein when determining the smallest subset of features that provides for optimal signal classification, the system is further configured to use the minimum feature set and perform operations of:
determining the effective decision boundary feature matrix (EDBFM);
creating a matrix by calculating the eigenvalues and eigenvectors of the EDBFM;
computing a rank of the matrix from non-zero eigenvalues, whereby the rank determines the smallest subset of features that provides for optimal signal classification of the set of N features.

27. A system as set forth in claim 26, wherein the system is further configured to determine the EDBFM by performing a calculation according to the following:
$$EDBFM = \frac{1}{{K}^{′}} {\int }_{{S}^{′}} N ( x ) {N}^{′} ( x ) p ( x ) ⅆ x ,$$
where N(x) is the unit normal vector of x, N′(x) is a vector perpendicular to the unit normal vector, p(x) is a probability density function,
$${K}^{′} = {\int }_{{S}^{′}} p ( x ) ⅆ x$$
and S′is the effective decision boundary which is defined as {x|h(x)=t, xεR₁ or R₂}, where R₁ is the smallest region that contains a certain portion P_{threshold} of class ω₁ and R₂ is the smallest region that contains a certain portion P_{threshold} of class ω₂.

28. A system as set forth in claim 27, wherein when determining the EDBFM, the system is further configured to derive the EDBFM in a multi-class problem having classes ω₁ and ω₂, by performing operations of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following operations, with {X₁,X₂,Λ,X_{L}} and {Y₁,Y₂,Λ,Y_{L}} being such samples for classes ω₁ and ω₂, respectively, and performing the following operations for class ω₁;
applying the chi-square threshold test of class ω₁ to the samples of ω₂ and retaining Yⱼ only if (Yⱼ−\hat{M}₁)^{t}\hat{Σ}₁⁻¹(Yⱼ−\hat{M}₁)<Rₜ₂;
for Xᵢ of class ω₁, finding the nearest samples of class ω₂ retained in the operation of applying and forming a straight line connecting the samples if the samples have two dimensions, and if the samples have more than two directions, forming a plane between the samples;
finding a point Pᵢ where the straight line or plane connecting the samples found in the operation of finding the nearest samples meets the decision boundary;
finding a unit normal vector Nᵢ to the decision boundary at the point Pᵢ;
computing L₁ unit normal vectors by repeating the operations of finding the nearest samples, finding a point Pᵢ, and finding a unit normal vector, for Xᵢ, I=1,2 . . . , L₁, and from these normal vectors computing an estimate of the EDBFM for class ω₁ using:
$${\sum }_{EDBFM}^{1} = \frac{1}{{L}_{1}} {\sum }_{i}^{{L}_{1}} {N}_{i} {N}_{i}^{T} ;$$
for class ω₂, repeating the operations of applying the chi-square threshold test, finding the nearest sample, finding a point Pᵢ, finding a unit normal vector, and computing unit normal vectors; and
calculating an estimate of a final EDBFM using: Σ_{EDBFM}=Σ_{EDBFM}¹+ΣEDBFM².

29. A system as set forth in claim 28, wherein in the operation of calculating an estimate of the final EDBFM, the final EDBFM is calculated in a multi-class problem according to the following:
$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$
where M is the number of classes, ΣDBFM^{ij} is the DBFM between classes ωᵢ and ωⱼ, and p(ωᵢ) is the prior probability of class ωᵢ.

30. A system as set forth in claim 24, wherein when determining the smallest subset of features that provides for optimal signal classification, the system is further configured to use the minimum feature set and perform operations of:
determining the effective decision boundary feature matrix (EDBFM);
creating a matrix by calculating the eigenvalues and eigenvectors of the EDBFM;
computing a rank of the matrix from non-zero eigenvalues, whereby the rank determines the smallest subset of features that provides for optimal signal classification of the set of N features.

31. A system as set forth in claim 30, wherein the system is further configured to determine the EDBFM by performing a calculation according to the following:
$$EDBFM = \frac{1}{{K}^{′}} {\int }_{{S}^{′}} N ( x ) {N}^{′} ( x ) p ( x ) ⅆ x ,$$
where N(x) is the unit normal vector of x, N′(x) is a vector perpendicular to the unit normal vector, p(x) is a probability density function,
$${K}^{′} = {\int }_{{S}^{′}} p ( x ) ⅆ x$$
and S′ is the effective decision boundary which is defined as {x|h(x)=t, xεR₁ or R₂}, where R₁ is the smallest region that contains a certain portion P_{threshold} of class ω₁ and R₂ is the smallest region that contains a certain portion P_{threshold} of class ω₂.

32. A system as set forth in claim 30, wherein when determining the EDBFM, the system is further configured to derive the EDBFM in a multi-class problem having classes ω₁ and ω₂, by performing operations of:
classifying training samples for classes ω₁ and ω₂ using the set of N features and applying a chi-square threshold test that provides an outlier to the classified training samples of each class, and deleting the outlier provided by the chi-square threshold test, such that for class ω₁, a sample X is retained only when (X−\hat{M}ᵢ)^{t}\hat{Σ}ᵢ⁻¹(X−\hat{M}ᵢ)<Rₜ₁, where \hat{M}ᵢ is the mean, \hat{Σ}ᵢ is the covariance of class ωᵢ, and subscript t denotes a particular threshold, and where only the classified training samples that passed the chi-square threshold test are used in the following operations, with {X₁, X₂,Λ, X_{L}} and {Y₁, Y₂,Λ, Y_{L}} being such samples for classes ω₁ and ω₂, respectively, and performing the following operations for class ω₁;
applying the chi-square threshold test of class ω₁ to the samples of ω₂ and retaining (Yⱼ−\hat{M}₁)^{t}\hat{Σ}₁⁻¹(Yⱼ−\hat{M}₁)<Rₜ₂;
for Xᵢ of class ω₁, finding the nearest samples of class ω₂ retained in the operation of applying and forming a straight line connecting the samples if the samples have two dimensions, and if the samples have more than two directions, forming a plane between the samples;
finding a point Pᵢ where the straight line or plane connecting the samples found in the operation of finding the nearest samples meets the decision boundary;
finding a unit normal vector Nᵢ to the decision boundary at the point Pᵢ;
computing L₁ unit normal vectors by repeating the operations of finding the nearest samples, finding a point Pᵢ, and finding a unit normal vector, for Xᵢ, I=1,2 . . . , L₁, and from these normal vectors computing an estimate of the EDBFM for class ω₁ using:
$${\sum }_{EDBFM}^{1} = \frac{1}{{L}_{1}} {\sum }_{i}^{{L}_{1}} {N}_{i} {N}_{i}^{T} ;$$
for class ω₂, repeating the operations of applying the chi-square threshold test, finding the nearest sample, finding a point Pᵢ, finding a unit normal vector, and computing unit normal vectors; and
calculating an estimate of a final EDBFM using: Σ_{EDBFM}=Σ_{EDBFM}¹+Σ_{EDBFM}².

33. A system as set forth in claim 32, wherein in the operation of calculating an estimate of the final EDBFM, the final EDBFM is calculated in a multi-class problem according to the following:
$${\sum }_{EDBFM} = {\sum }_{i}^{M} {\sum }_{j , j \neq i}^{M} p ( {ω}_{i} ) p ( {ω}_{j} ) {\sum }_{DBFM}^{ij} ,$$
where M is the number of classes, Σ_{DBFM}^{ij} is the DBFM between classes ωᵢ and ωⱼ, and p(ωᵢ) is the prior probability of class ωᵢ.
